(19) United States
(12) Patent Application Publication
(10) Pub. No.: US 2017/0259422 A1
(43) Pub. Date: Sep. 14, 2017

(54) TIP TOOL HOLDER AND POWER TOOL

(71) Applicant: Panasonic Intellectual Property Management Co., Ltd., Osaka (JP)

(72) Inventors: Atusi TAKEYAMA, Mie (JP); Fumiaki Sawano, Mie (JP); Daiju Kinoshita, Mie (JP)

(21) Appl. No.: 15/454,499

(22) Filed: Mar. 9, 2017

(30) Foreign Application Priority Data
Mar. 10, 2016 (JP) 2016-047518

(51) Int. Cl. B25F 5/02; B25H 3/00

(52) U.S. Cl. CPC B25F 5/029; B25H 3/003

(57) ABSTRACT

A tip tool holder includes a nail portion to be inserted in an attachment hole formed in a power tool, an accommodation portion capable of accommodating a tip tool, and an opening opposite to the nail portion. The accommodation portion accommodates the tip tool such that an axis of the tip tool is substantially perpendicular to a direction in which the nail portion and the opening face each other. The tip tool holder includes a first arm and a second arm opposite to each other. The opening is included in the first arm while the nail portion is provided to the second arm.

### CROSS-REFERENCE TO RELATED APPLICATIONS

This application is based upon and claims the benefit of priority of Japanese Patent Application Number 2016-47518, filed on Mar. 10, 2016, the entire contents of which are hereby incorporated by reference.

### BACKGROUND

1. Field of the Disclosure

The disclosure relates to a structure that holds a tip tool such as a spare bit.

2. Description of the Related Art

There are cases where a tip tool such as a bit has to be replaced due to abrasion or other reasons during work using a power tool. When a plurality of types of work is performed using one power tool, there are cases where the tip tool is replaced depending on the type of work. It is preferable that the power tool holds a spare tip tool for such cases.

For example Japanese Unexamined Patent Application Publication No. 2005-297192 discloses a bit accommodation structure in which a bit accommodation portion that accommodates a bit is included in a recessed manner in a hook that can be hooked at a waist belt or other items of a worker. Japanese Unexamined Patent Application Publication No. 2004-255503 discloses a portable power tool in which a socket part for fitting a bit is included on an upper surface of a base of a handle.

Since a holding structure of a spare bit may be damaged, it is preferable that the holding structure is configured detachably from a power tool and that a part is easily replaceable as necessary.

It is also preferable that the holding structure of the spare bit holds a tip tool such that the tip tool does not come in contact with a floor surface when the power tool is placed on the floor surface.

### SUMMARY

One aspect of the present invention has been devised in consideration to such circumstances. An object of one aspect of the present invention is to provide a structure that holds a tip tool such as a spare bit.

In order to solve the above issue, an embodiment of the present invention relates to a tip tool holder attachable to a power tool. The tip tool holder includes a nail portion to be inserted in an attachment hole formed in the power tool, an accommodation portion capable of accommodating a tip tool, and an opening opposite to the nail portion.

Another embodiment of the present invention is a power tool including a gripping portion. The power tool includes a pair of attachment holes formed on the right and the left at a base under the gripping portion and an attachment portion for attaching an insertion portion of a hook inserted in the attachment hole to the base. The tip tool holder is mounted to the power tool by inserting a nail portion of the tip tool holder including an accommodation portion capable of accommodating a tip tool into one of the attachment holes and, while an opening of the tip tool holder overlaps with the other attachment hole, attaching, to the base by the attachment portion, the insertion portion of the hook inserted in the opening and the other attachment hole.

### BRIEF DESCRIPTION OF THE DRAWINGS

The figures depict one or more implementations in accordance with the present teaching, by way of example only, not by way of limitations. In the figures, like reference numerals refer to the same or similar elements.

FIG. 1 is a side view of a power tool of an embodiment;

FIG. 2 is a perspective view of a tool main body when viewed from a lower surface side;

FIG. 3 is a cross-sectional view of an attachment portion;

FIG. 4 is a perspective view of a tip tool holder;

FIGS. 5A to 5C are diagrams for explaining procedures for attaching the tip tool holder to a rear surface of a base;

FIG. 6 is a diagram illustrating the tip tool holder attached to the power tool;

FIG. 7 is a cross-sectional view of an attachment portion of a variation;

FIGS. 8A and 8B are diagrams illustrating a tip tool holder of a variation; and

FIGS. 9A and 9B are diagrams illustrating a tip tool holder of a variation.

### DETAILED DESCRIPTION

One aspect of the present invention will now be described by reference to the preferred embodiments. This does not intend to limit the scope of one aspect of the present invention, but to exemplify the teachings.

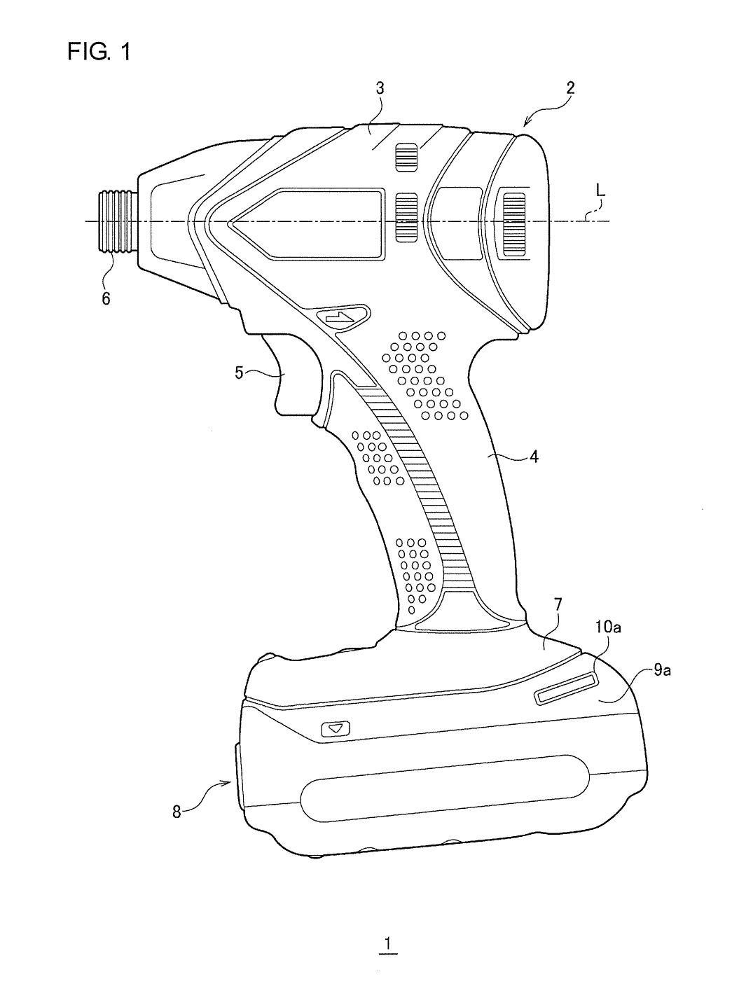

FIG. 1 is a side view of a power tool 1 of an embodiment. The power tool 1 of the embodiment includes a tool main body 2 and a detachable battery pack 8 incorporating a secondary battery. A housing forming an exterior structure of the tool main body 2 includes a body portion 3 of a cylindrical shape with a bottom, a gripping portion 4 extending downward from the body portion 3, and a base 7 formed under the gripping portion 4. The gripping portion 4 forms a grip for a worker to grasp. A front surface of the gripping portion 4 is formed with an operation switch 5 for a worker to operate. A rear surface of the base 7 is attached with the battery pack 8 formed by a box-shaped case.

The body portion 3 of the housing accommodates a motor that is a driver, a deceleration mechanism that decelerates revolutions of the motor, and a driving transfer mechanism such as an output shaft that rotates at a decelerated number of revolutions. A tip of the output shaft extends outside the body portion 3 and is provided with a tool mounting portion 6 for mounting a tip tool such as a driver bit. In the embodiment, a direction in which the tool mounting portion 6 extends along an axis L of the output shaft is referred to as a longitudinal direction. A direction in which the gripping portion 4 substantially extends and perpendicular to the longitudinal direction is referred to as a vertical direction. A direction perpendicular to the longitudinal direction and the vertical direction is referred to as a lateral direction.

The power tool 1 of the embodiment has a structure for attaching a hanging tool (hook) for hanging the power tool 1 to a waist belt or other items of a worker when the worker does not use the power tool 1.

The base 7 includes side walls on the right and the left. On each of the right and the left side walls of the base 7 an attachment hole for inserting an insertion portion of the hook therein is formed. Including the attachment holes on the right and the left side walls allows a worker to attach the hook at a desired position on the right or the left. For example a right-handed worker hangs the power tool 1 on the right side of the body and thus attaches the hook on the left side wall when viewed from a rear side of the power tool 1. A left-handed worker hangs the power tool 1 on the left side of the body and thus attaches the hook on the right side wall when viewed from the rear side of the power tool 1. In FIG. 1 a left side wall 9a positioned on the left side when viewed from the rear side of the power tool and an attachment hole 10a formed on the left side wall 9a are illustrated.

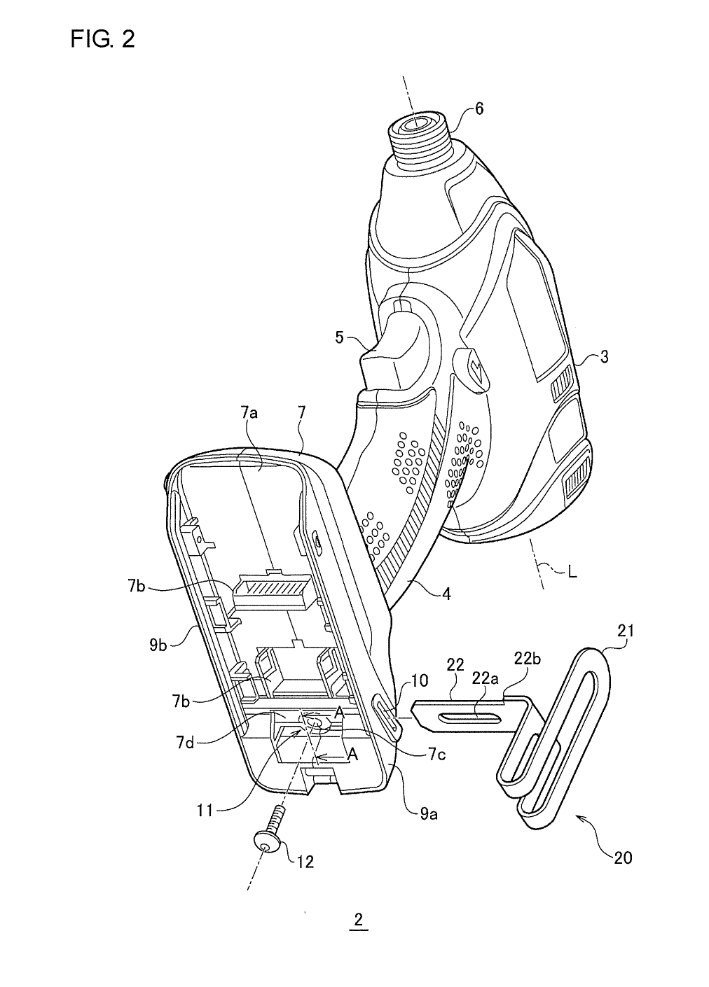

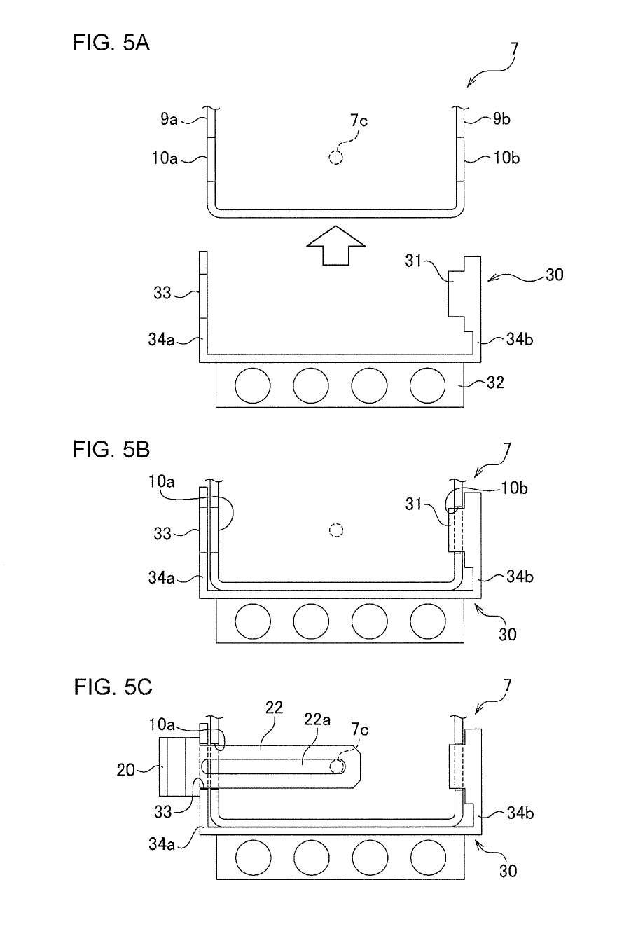

FIG. 2 is a perspective view of the tool main body 2 when viewed from a lower surface side. The base 7 has a bilaterally symmetric shape in appearance. The left side wall 9a and the right side wall 9b extend downward from a bottom portion 7a. The left side wall 9a includes the attachment hole 10a and the right side wall 9b includes an attachment hole 10b (see FIGS. 5A to 5C). Hereinafter, the attachment holes 10a and 10b are referred to as the “attachment hole 10” when not specifically distinguished. The bottom portion 7a includes a connection terminal 7b that electrically connects the battery pack 8 to the motor or a control circuit. The bottom portion 7a also includes an attachment portion 11 to which a hook 20 is fixed.

The hook 20 includes a hooking portion 21 to be hung at a belt of a worker and an insertion portion 22 to be inserted in the attachment hole 10. The insertion portion 22 includes an opening 22a to be inserted with a fastener 12. The hooking portion 21 and the insertion portion 22 are integrally formed by a resin material or a metal material.

The hooking portion 21 has a shape where a plate material, the center of which is missing, is bent into substantially a U-letter shape. The insertion portion 22 is formed into a flat plate shape. A cross-sectional shape of the insertion portion 22 has a shape that can be inserted in the attachment hole 10 of the base 7. The insertion portion 22 is inserted from the attachment hole 10 to the attachment portion 11 and the fastener 12 which is a screw is inserted into the opening 22a and fixed to a screw hole 7c in the bottom portion 7a, thereby attaching the insertion portion 22 to the bottom portion 7a of the base 7.

In this manner, the power tool 1 has a structure for fixing the hook 20 to the side wall of the base 7. Note that in FIG. 2 the example where the hook 20 is fixed to the left side wall 9a is illustrated; however, the hook 20 may be fixed to the right side wall 9b in a similar manner.

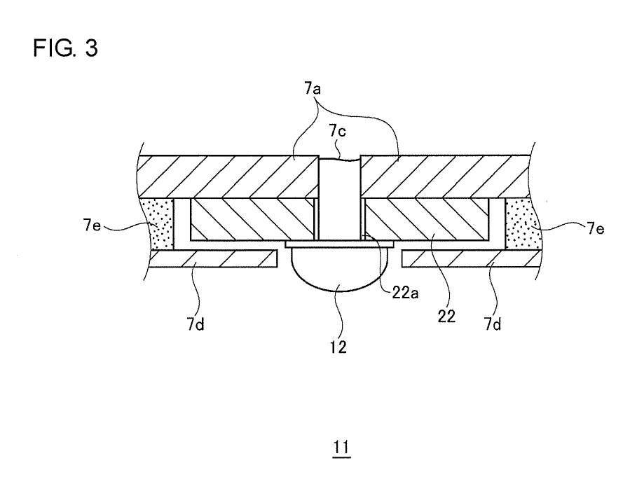

FIG. 3 is a cross-sectional view of the attachment portion 11. The attachment portion 11 is formed at an intermediate position between the attachment hole 10a of the left side wall 9a and the attachment hole 10b of the right side wall 9b and has a structure for attaching the insertion portion 22 to the base 7 by inserting the fastener 12 in the opening 22a of the insertion portion 22. An insertion path of the insertion portion 22 is linearly formed between the attachment holes 10 of the right and the left side walls. The insertion path is defined by the bottom portion 7a, guide lower plates 7d, and guide walls 7e. The guide lower plates 7d limit inclination in the vertical direction of the insertion portion 22 while the guide walls 7e limit inclination in the lateral direction of the insertion portion 22. While the insertion portion 22 is inserted in the attachment hole 10 until a wide insertion limiting portion 22b abuts against an edge of the attachment hole 10 and a tip of the opening 22a overlaps with the screw hole 7c, the insertion portion 22 is attached to the bottom portion 7a by the fastener 12. As a result of this, the hook 20 is fixed to the tool main body 2.

As described above, the power tool 1 has a structure that allows the hook 20 to be attached to either one of the left side wall 9a and the right side wall 9b of the base 7. An embodiment provides a tip tool holder attachable to the tool main body 2 leveraging this structure.

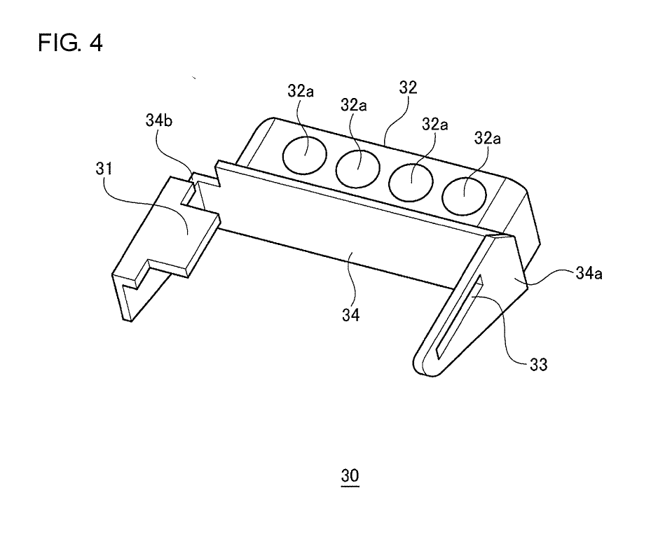

FIG. 4 is an exemplary perspective view of a tip tool holder 30 attachable to the power tool 1. The tip tool holder 30 includes a nail portion 31 to be inserted in an attachment hole 10, an accommodation portion 32 capable of accommodating a tip tool, and an opening 33 opposite to the nail portion 31. The tip tool holder 30 includes a support 34 supporting the accommodation portion 32 on a rear surface thereof. A first arm 34a and a second arm 34b that make a pair extend from both ends of the support 34. An opening 33 is included in the first arm 34a and the nail portion 31 is provided to the second arm 34b. The first arm 34a and the second arm 34b are opposite to each other and thus the opening 33 and the nail portion 31 are also opposite to each other.

The tip tool holder 30 is attached to a rear surface of the power tool 1. The nail portion 31 and the opening 33 are positioned at the same height in the vertical direction of the tip tool holder 30. When the nail portion 31 is inserted into the attachment hole 10b included on the right side wall 9b of the base 7 upon attaching to the rear surface of the power tool, the opening 33 is disposed at a position overlapping with the attachment hole 10a included on the left side wall 9a. A cross-sectional shape of the nail portion 31 is formed into a shape that can be inserted in the attachment hole 10 and preferably has a width slightly narrower than that of the attachment hole 10 as well as a height slightly shorter than that of the attachment hole 10. This cross-sectional shape allows the nail portion 31 to be stably fitted into the attachment hole 10 when the nail portion 31 is inserted in the attachment hole 10.

The opening 33 that is a through hole is inserted with the insertion portion 22 of the hook 20 while disposed outside the attachment hole 10. Therefore a cross-sectional shape of the opening 33 is formed into a shape that can be inserted with the insertion portion 22 and may have the same shape as that of the attachment hole 10. A lateral width of the support 34 is set according to the distance between the right and the left attachment holes 10 included in the base 7.

The accommodation portion 32 can accommodate the tip tool such that an axis of the tip tool is substantially perpendicular to a direction in which the nail portion 31 and the opening 33 face each other. That is, the accommodation portion 32 includes holding grooves 32a that hold a tip tool in an upright state.

FIGS. 5A to 5C are diagrams for explaining procedures for attaching the tip tool holder 30 to the rear surface of the base 7. As illustrated in FIG. 5A, the attachment hole 10a is formed on the left side wall 9a of the base 7 while the attachment hole 10b is formed on the right side wall 9b. The screw hole 7c is formed at the intermediate position between the attachment hole 10a and the attachment hole 10b. The tip tool holder 30 is held closer toward the rear surface of the base from a rear side thereof and the nail portion 31 of the tip tool holder 30 is inserted into the attachment hole 10b of the base 7.

FIG. 5B is a diagram illustrating the nail portion 31 inserted in the attachment hole 10b. The first arm 34a and the second arm 34b of the tip tool holder 30 has flexibility and thus the arms can open. Upon inserting the nail portion 31 into the attachment hole 10b, the first arm 34a and the second arm 34b are caused to open by leveraging this flexibility and the nail portion 31 is thereby inserted into the attachment hole 10b.

Since the opening 33 formed in the first arm 34a is included at the same height as that of the nail portion 31 in the tip tool holder 30 and thus is arranged at a position overlapping with the attachment hole 10a of the left side wall 9a from outside. This allows the insertion portion 22 of the hook 20 to be inserted into the opening 33 and the attachment hole 10a.

FIG. 5C is a diagram illustrating the insertion portion 22 of the hook 20 inserted in the opening 33 and the attachment hole 10a. Inserting the insertion portion 22 in the opening 33 and the attachment hole 10a allows the first arm 34a and the second arm 34b of the tip tool holder 30 to be engaged with the base 7. The fastener 12 which is a screw is then inserted into the opening 22a and fastened in the screw hole 7c, thereby fixing the tip tool holder 30 to the base 7. Note that, for detaching the tip tool holder 30 from the base 7, performing reverse procedures to the aforementioned attaching procedures results in easily detaching the tip tool holder 30 from the base 7.

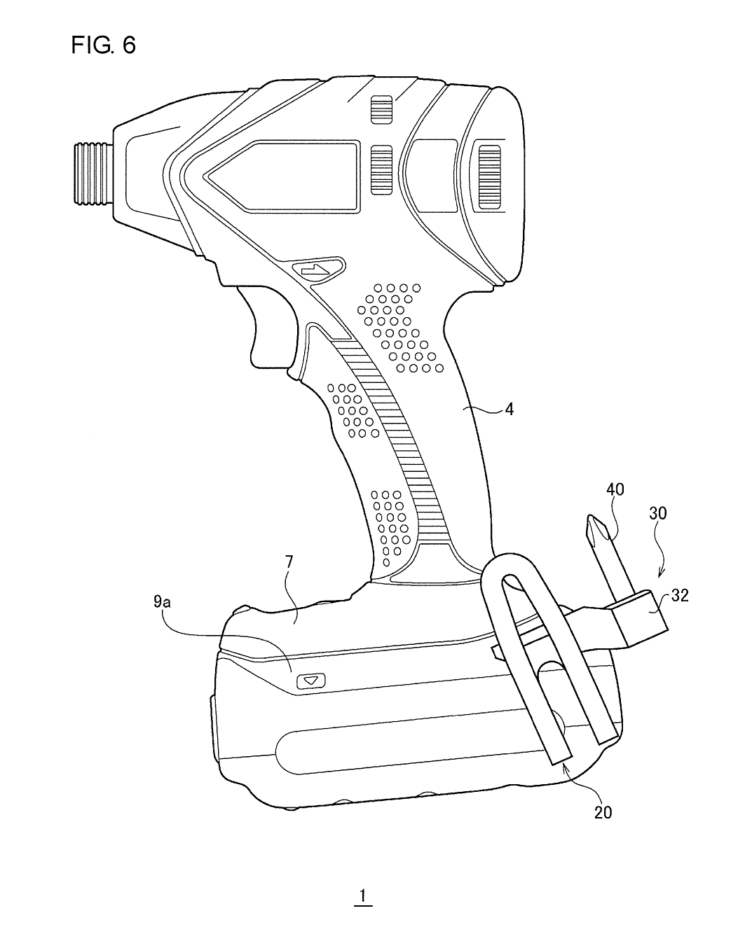

FIG. 6 is a diagram illustrating the tip tool holder 30 attached to the power tool 1. As illustrated in FIG. 6, the accommodation portion 32 of the tip tool holder 30 accommodates a tip tool 40 in an upright state. Therefore an axial direction of the tip tool 40 held in the accommodation portion 32 is perpendicular to the lateral direction of the power tool 1.

When the power tool 1 is placed on a floor surface, the power tool 1 is unstable in an upright state and thus is laid with a side surface facing down. In this example, the hook 20 is attached to the left side wall 9a which is a left side surface when viewed from the rear side. A worker therefore places the power tool 1 on a floor surface with a right side surface thereof facing down. If an axis of the tip tool 40 is held in the lateral direction of the power tool 1 in the tip tool holder, a tip of the tip tool 40 may be in contact with and thereby damage the floor surface. Regarding this point, the tip tool holder 30 of the embodiment holds the tip tool 40 not laterally but vertically and thus the tip tool 40 does not come in contact with the floor surface even when the power tool 1 is placed on the floor surface with the side surface thereof facing down.

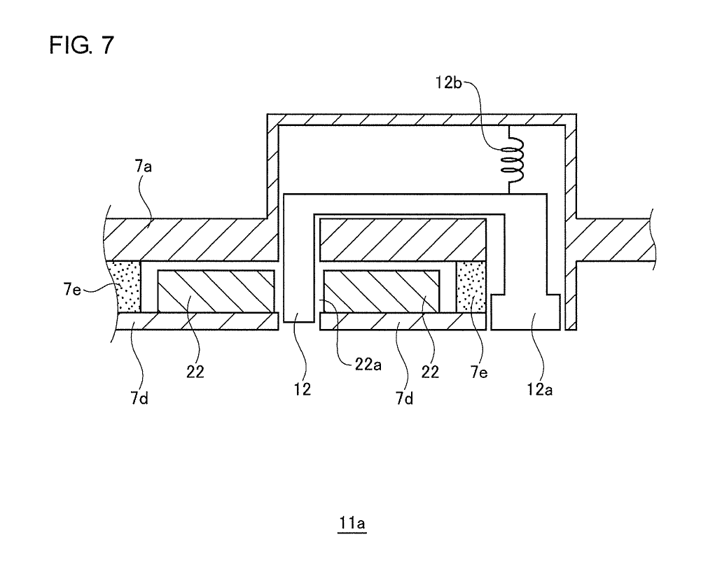

FIG. 7 is a cross-sectional view of an attachment portion of a variation. The attachment portion 11a is formed at an intermediate position between the attachment hole 10a of the left side wall 9a and the attachment hole 10b of the right side wall 9b and has a structure for attaching the insertion portion 22 to the base 7 by inserting a fastener 12 in the opening 22a of the insertion portion 22. An insertion path of the insertion portion 22 is linearly formed between the attachment holes 10 of the right and the left side walls. The insertion path is defined by the bottom portion 7a, guide lower plates 7d, and guide walls 7e. The guide lower plates 7d limit inclination in the vertical direction of the insertion portion 22 while the guide walls 7e limit inclination in the lateral direction of the insertion portion 22.

The attachment portion 11a illustrated in FIG. 7 attaches the insertion portion 22 to the base 7 by the fastener 12 which is an engaging member. This is different from the structure of the attachment portion 11 illustrated in FIG. 3. The fastener 12 is energized toward the guide lower plates 7d by an elastic member 12b which is a coil spring. The fastener 12 is connected to a push bottom 12a exposed from the guide lower plates 7d. A worker can engage the fastener 12 to the opening 22a of the insertion portion 22 and disengage the fastener 12 from the opening 22a by pressing the push bottom 12a. Engagement of the fastener 12 with the opening 22a results in attaching the insertion portion 22 to the base 7. As a result of this, the hook 20 is fixed to the tool main body 2.

According to the attachment portion 11a, the insertion portion 22 is not fastened by a screw and thus the hook 20 can be easily attached to the tool main body 2 without a fastening tool such as a driver. Note that in the example illustrated in FIG. 7 the fastener 12 is engaged with the opening 22a of the insertion portion 22; however, protrusions of a sawtooth shape may be formed on a side surface of the insertion portion 22 and the insertion portion 22 may be attached to the base 7 by engaging the fastener 12 to those protrusions.

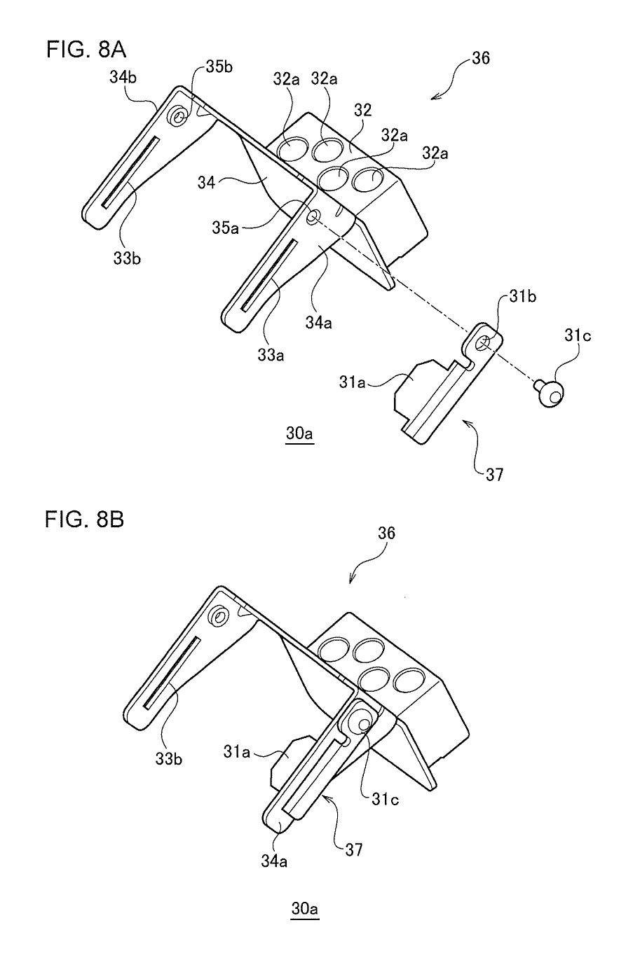

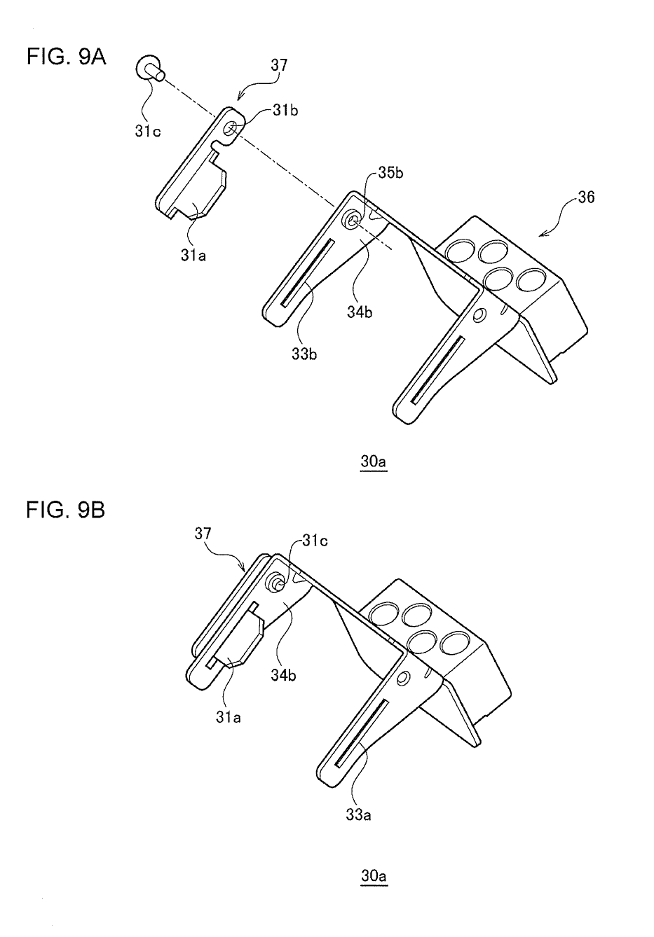

FIGS. 8A and 8B and FIGS. 9A and 9B are diagrams illustrating a tip tool holder 30a of a variation. The tip tool holder 30a has a structure where a nail portion 31a to be inserted in the attachment hole 10 of the power tool 1 can be separated from a holder main body 36.

FIG. 8A is a perspective view of the holder main body 36 and a nail body 37. The holder main body 36 includes an accommodation portion 32 capable of accommodating a tip tool and a first opening 33a and a second opening 33b opposite to each other. The holder main body 36 includes a support 34 supporting the accommodation portion 32 on a rear surface thereof. A first arm 34a and a second arm 34b extend from both ends of the support 34. The first arm 34a and the second arm 34b are opposite to each other and thus the first opening 33a and the second opening 33b are also opposite to each other.

The first arm 34a and the second arm 34b include a first insertion hole 35a and a second insertion hole 35b, respectively, to which a fastener 31c for fixing the nail body 37 is attached. In the first arm 34a, the first insertion hole 35a is positioned on a line extending from the first opening 33a and parallel to a longitudinal direction of the first opening 33a. In other words, the first opening 33a and the first insertion hole 35a are positioned at the same height. In the second arm 34b, the second insertion hole 35b is positioned on a line extending from the second opening 33b and parallel to a longitudinal direction of the second opening 33b. In other words, the second opening 33b and the second insertion hole 35b are positioned at the same height.

The nail body 37 is formed as a part independent from the holder main body 36. The nail body 37 includes a nail portion 31a to be inserted in the attachment hole 10 and an insertion hole 31b in which the fastener 31c is be inserted. In the nail body 37, the insertion hole 31b is positioned on a line extending from the nail portion 31a and parallel to a longitudinal direction (width direction) of the nail portion 31a. In other words, the nail portion 31a and the insertion hole 31b are positioned at the same height.

The above configuration allows the nail portion 31a to be attached to either one of the first opening 33a and the second opening 33b.

FIG. 8B is a diagram illustrating the nail body 37 fixed to the first arm 34a. The nail portion 31a is inserted in the first opening 33a and protrudes inward from the first arm 34a. As a result of this the nail portion 31a and the second opening 33b face each other and the tip tool holder 30a becomes attachable to the base 7 of the power tool 1.

For example when the hook 20 is attached to the attachment hole 10b on the right side surface when the tool main body 2 is viewed from the rear side, the nail portion 31a of the tip tool holder 30a is inserted in the attachment hole 10a on the left side wall 9a of the tool main body 2. Whether the hook 20 is attached to the right side surface or the left side surface depends on a dominant hand of a worker. According to the tip tool holder 30a, the nail portion 31a is attachable to either one of the first arm 34a and the second arm 34b. Therefore, the tip tool holder 30a is attachable to the tool main body 2 whether the hook 20 is attached to the right side surface or the left side surface of the tool main body 2.

The accommodation portion 32 includes a plurality of holding grooves 32a that holds tip tools such that an axis of the tip tool is substantially perpendicular to a direction in which the first opening 33a and the second opening 33b are facing each other. In the accommodation portion 32 illustrated in FIG. 8A, the plurality of holding grooves 32a are disposed in the lateral direction while partially overlapping in the longitudinal direction. Disposing the plurality of holding grooves 32a in a zigzag manner in the longitudinal direction allows the width length in the lateral direction to be shorter as compared to disposing the holding grooves 32a in a line in the lateral direction. As described above, the power tool 1 may be placed on a floor surface with a side surface not provided with the hook 20 facing down and thus the width of the accommodation portion 32 in the lateral direction is preferably narrower than the width of the support 34. It is suitable that the plurality of holding grooves 32a are disposed while overlapping in the longitudinal direction in order to increase the number of tip tools that can be held in the accommodation portion 32.

FIG. 9A is a perspective view of the holder main body 36 and a nail body 37. In this example, a nail portion 31a of the nail body 37 is inserted in a second opening 33b of a second arm 34b. As compared to the nail body 37 illustrated in FIG. 8A, the nail body 37 illustrated in FIG. 9A is rotated by 180 degrees around an axis of rotation in the longitudinal direction. In the nail body 37, the nail portion 31a and the insertion hole 31b are positioned at the same height while the second opening 33b and the second insertion hole 35b are positioned at the same height in the second arm 34b. Therefore the insertion hole 31b and the second insertion hole 35b overlap with each other when the nail portion 31a is inserted in the second opening 33b.

FIG. 9B is a diagram illustrating the nail body 37 fixed to the second arm 34b. The nail portion 31a is inserted in the second opening 33b and protrudes inward from the second arm 34b. As a result of this the nail portion 31a and the first opening 33a face each other and the tip tool holder 30a becomes attachable to the base 7 of the power tool 1.

In this manner, according to the tip tool holder 30a, the nail portion 31a can be fixed to either one of the first opening 33a and the second opening 33b and thus is attached to the tool main body 2 without limited by a position where the hook 20 is attached.

An overview of an embodiment of the present invention is as follows.

A tip tool holder (30, 30a) of an embodiment of the present invention is attachable to a power tool (1) and includes: a nail portion (31, 31a) inserted in an attachment hole (10a or 10b) formed in the power tool; an accommodation portion (32) capable of accommodating a tip tool; and an opening (33) opposite to the nail portion.

The accommodation portion (32) may be capable of accommodating the tip tool such that an axis of the tip tool is substantially perpendicular to a direction in which the nail portion (31, 31a) and the opening (33) face each other. The tip tool holder may include a pair of arms (34a and 34b) opposite to each other. The nail portion (31) may be provided to one of the arms while the opening (33) may be included in the other arm.

The tip tool holder (30a) may include a first opening (33a) and a second opening (33b) opposite to each other. The nail portion (31a) may be inserted in and fixed to either one of the first opening and the second opening. The tip tool holder may be supported by the power tool while the opening (33) overlaps with the attachment hole (10a) that is different from the attachment hole (10b) inserted with the nail portion (31) and an insertion portion (22) of a hook is inserted therein.

A power tool (1) of another embodiment of the present invention includes a gripping portion (4). The power tool (1) includes a pair of attachment holes (10a and 10b) formed on the right and the left at a base (7) under a gripping portion and an attachment portion (11, 11a) for attaching, to the base, an insertion portion (22) of a hook (20) inserted in the attachment hole. The tip tool holder is mounted to the power tool by inserting a nail portion (31) of the tip tool holder (30) including an accommodation portion (32) capable of accommodating a tip tool into one of the attachment holes and, while an opening (33) of the tip tool holder overlaps with the other attachment hole, attaching, to the base by the attachment portion, the insertion portion (22) of the hook inserted in the opening and the other attachment hole.

The attachment portion (11a) may include a fastener (12) that is engaged with the insertion portion of the hook and an elastic member (12b) energizing the fastener.

One aspect of the present invention has been described above based on the embodiments. These embodiments are merely examples. Therefore, it should be understood by a person skilled in the art that combinations of the components or processing processes of the examples may include various variations and that such a variation is also within the scope of the present teachings.

In the embodiment, descriptions have been given on that the tip tool holder 30 is supported by the power tool 1 by inserting the insertion portion 22 of the hook 20 in the opening 33 of the tip tool holder 30 and fixing the insertion portion 22 to the base 7. In a variation, however, a dedicated fixing tool for supporting the tip tool holder 30 may be used instead of the insertion portion 22 of the hook 20 for the tip tool holder 30 to be supported by the power tool 1. The dedicated fixing tool may have the same shape as those of the insertion portion 22 and the insertion limiting portion 22b.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

What is claimed is:

1. A tip tool holder attachable to a power tool, comprising:
a nail portion inserted in an attachment hole formed in the power tool;
an accommodation portion capable of accommodating a tip tool; and
an opening opposite to the nail portion.

2. The tip tool holder according to claim 1,
wherein the accommodation portion is capable of accommodating the tip tool such that an axis of the tip tool is substantially perpendicular to a direction in which the nail portion and the opening face each other.

3. The tip tool holder according to claim 1, further comprising a pair of arms opposite to each other,
wherein the nail portion is provided to one of the arms while the opening is included in the other arm.

4. The tip tool holder according to claim 1, further comprising a first opening and a second opening opposite to each other,
wherein the nail portion is inserted in and fixed to either one of the first opening and the second opening.

5. The tip tool holder according to claim 1,
wherein the tip tool holder is supported by the power tool while the opening overlaps with an attachment hole that is different from the attachment hole inserted with the nail portion and an insertion portion of a hook is inserted therein.

6. A power tool, comprising:
a gripping portion;
a pair of attachment holes formed on the right and the left at a base under the gripping portion; and
an attachment portion for attaching, to the base, an insertion portion of a hook inserted in the attachment hole,
wherein a tip tool holder is mounted to the power tool by inserting a nail portion of the tip tool holder including an accommodation portion capable of accommodating a tip tool into one of the attachment holes and, while an opening of the tip tool holder overlaps with the other attachment hole, attaching, to the base by the attachment portion, the insertion portion of the hook inserted in the opening and the other attachment hole.

7. The power tool according to claim 6,
wherein the attachment portion comprises a fastener that is engaged with the insertion portion of the hook and an elastic member energizing the fastener.
